(19) United States
(12) Patent Application Publication
(10) Pub. No.: US 2011/0005394 A1
(43) Pub. Date: Jan. 13, 2011

(54) MEDIA FOR REMOVAL OF ORGANIC COMPOUNDS

(76) Inventors: Jon D. Joriman, Little Canada, MN (US); Andrew J. Dallas, Apple Valley, MN (US); Jeremy Exley, Minneapolis, MN (US); Brian Babcock, Shakopee, MN (US); Keh B. Dema, Plymouth, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 12/668,843

(22) PCT Filed: Jul. 13, 2008
(86) PCT No.: PCT/US2008/069904

§ 371 Date: May 28, 2010

Related U.S. Application Data
(60) Provisional application No. 60/949,839, filed on Jul. 13, 2007.

(51) Int. Cl. B01D 53/02; B01D 39/14; C01B 31/08

(52) U.S. Cl. 95/141; 96/154; 96/152; 502/416

(57) ABSTRACT

An air filter having a low pressure drop and adsorbent capabilities when placed in a fluid stream is disclosed. The air filter contains activated carbon incorporated into a filter media that can be shaped into a fluted configuration. The fluted shape is maintained during operation of the air filter through the use of flow restrictors along the length of the flute. The fluted material can be rolled or stacked.

This application is being filed as a PCT International Patent application on Jul. 11, 2008, in the name of Donaldson Company, Inc., a U.S. national corporation, applicant for the designation of all countries except the U.S., and Jon D. Joriman, a U.S. Citizen, Andrew Dallas, a U.S. Citizen, Jeremy Exley, a U.S. Citizen, Brian Babcock, a U.S. Citizen, Keh Dema, a U.S. Citizen, applicants for the designation of the U.S. only, and claims priority to U.S. Patent Application Ser. No. 60/949,839, titled “Media for Removal of Organic Compounds”, filed Jul. 13, 2007; the contents of which are herein incorporated by reference.

### TECHNICAL FIELD

The present invention relates to media and filter constructions for removing organic compounds from an air stream.

### BACKGROUND OF THE INVENTION

Filters are desired that have a low pressure drop, are lightweight, and have a high-efficiency filtering organic compounds, including volatile organic compounds (VOCs), from a fluid stream that is dry or contains significant amounts of water, for example, an air stream. Although a variety of fluid filter arrangements have been developed for removal of organic compounds from an air stream, certain needs still exist for filters having a high level of adsorption of organic compounds in conjunction with a low pressure drop. Such filters are necessary for clean rooms used in many manufacturing processes, for use in cabin air (such as aircraft cabins), and for use in numerous other applications.

### SUMMARY OF THE INVENTION

The present invention is directed, in part, to a filter media substrate suitable for the efficient removal of low concentration (<100 ppm) organic compounds, typically VOCs, from a gas stream using a low pressure drop. The filter media substrate of the present invention can be further treated with reactive agents for other filtration applications, such as acid and base gas removal. The fluid flow is directed through an open channel and/or through the wall of the filter media substrate such that organic compounds are readily removed without excessive restriction of flow through the filter media. Thus, the present invention is particularly useful for applications where low resistance to flow is desirable, or where high flow rates must be obtained. In addition, the filter media removes fine and ultrafine particles, and has shown to provide excellent removal of nanoparticles from air streams in some embodiments.

The invention is directed, in part, to a filter device capable of removing volatile organic compounds from stagnant or flowing fluid streams comprising fluted filter media having a plurality of flutes extending from a first end to a second end of the filter media. Activated carbon is incorporated into the fluted filter media. The device is constructed in some embodiments such that at least some of the plurality of flutes are obstructed so that fluid enters the filter device at a first flute but exits the filter device at a second flute. In certain embodiments the fluted filter media comprises flow restrictors along the length of the flutes. Often the flow restrictors provide structural support to prevent the filter from collapsing or tearing. Typically the flow restrictors comprise total plugs or partial flow restrictors. In other embodiments, no flow restrictors are present.

In certain embodiments the activated carbon comprises activated carbon fibers, such as chemically impregnated activated carbon. The chemically impregnated activated carbon can also be treated with reactive agents of aqueous or organic solutions for acidic and/or basic gas removal.

It will be understood that the filter media made in accordance with the present invention can have various levels of activated carbon present. In certain elements the filter material has greater than 50 percent carbon by weight, typically greater than 60 percent carbon by weight, and often greater than 70 percent carbon by weight. In some embodiments the amount of activated carbon is from 50 to 90 percent by weight, often from 60 to 80 percent carbon by weight.

Filter elements made in accordance with the present invention typically demonstrate a low pressure drop. Pressure drops on the order of 0 to 2.5 m²/second.

Typically the pressure drop is in the range of 0-160 cfm with a range of 0 to 16 inches of water. In certain embodiments, filter elements demonstrate airflow of nearly 160 scfm at pressure drop of below 16 inches of water, more frequently below 14 inches of water, and desirably below 8 inches of water.

For example, a 250 mm thick element of the present invention demonstrates, a pressure drop of less than 800 Pa at a velocity of 1.0 m/s of air flow; often less than 600 Pa pressure drop, and desirably less than 400 Pa pressure drop. Similarly, in some implementations a 250 mm thick element of the present invention demonstrates, a pressure drop of less than 1,000 Pa at a velocity of 2.0 m/s of air flow; often less than 600 Pa pressure drop, and desirably less than 400 Pa pressure drop.

The present invention overcomes the limitations of the prior art, granular packed beds of activated carbon and activated carbon fiber cloth for VOC removal by incorporating activated carbon into a filter media substrate that can maintain a fluted shape. The fluted shape is maintained, for example, through the use of flow restrictors at different locations along the length of the flutes. The flow restrictors provide structural support for the filter media along the length of the filter element and without this additional support, the flutes would potentially tear or collapse during operation of the filter. Additionally, with the additional support, thinner filter media can be used in the filter leading to increased overall media area without increase filter volume. This increased media area leads to greater filtering capacity.

The fluted shape in conjunction with activated carbon lowers the final product weigh, cost, and overall pressure drop; and leads to an increase in overall adsorption efficiency. Additionally, in an embodiment of the invention, the activated carbon fibers, in combination with various non-flammable fibers, renders the overall filter element flame retardant. This material can withstand an open flame and will not burn, leading to application in the fields of aerospace and other flame sensitive areas.

This summary of the present invention is merely an overview of some of the teachings of the present application and is not intended to describe each disclosed embodiment or every implementation of the present invention. Further embodiments will be found in the figures, detailed descriptions, and claims. The scope of the present invention should be determined by the appended claims and their legal equivalents.

### BRIEF DESCRIPTION OF THE DRAWINGS

The invention may be more completely understood in connection with the following drawings, in which:

FIG. 1 is a top perspective view of a filter assembly constructed in accordance with an implementation of the invention.

FIG. 2 is a top plan view of a filter assembly constructed in accordance with an implementation of the invention.

FIG. 3 is a partial exploded view of a segment of filter media constructed in accordance with an implementation of the invention.

FIG. 4 is an electron micrograph of filter media constructed and arranged in accordance with an implementation of the invention.

FIG. 5 is an electron micrograph of filter media constructed and arranged in accordance with an implementation of the invention.

FIG. 6 is an electron micrograph of filter media constructed and arranged in accordance with an implementation of the invention.

FIG. 7 is an electron micrograph of filter media constructed and arranged in accordance with an implementation of the invention.

FIG. 8 is a chart showing organic removal compared to pressure drop of various filter elements.

FIG. 9 is a chart showing organic chemical breakthrough of various filter elements.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

The present invention is directed, in part, to a filter media substrate suitable for the efficient removal of low concentration (<100 ppm) organic compounds from a gas stream using a low pressure drop. The filter media substrate of the present invention can be further treated with reactive agents for other filtration applications such as acid and base gas removal. The fluid flow is directed through an open channel and/or through the wall of the filter media substrate such that organic compounds are readily removed without excessive restriction of flow through the filter media. Thus, the present invention is particularly useful for applications where low resistance to flow is desirable, or where high flow rates must be obtained.

The invention is directed, in part, to a filter device capable of removing volatile organic compounds from stagnant or flowing fluid streams comprising fluted filter media having a plurality of flutes extending from a first end to a second end of the filter media. Activated carbon is incorporated into the fluted filter media. The device is constructed such that at least some of the plurality of flutes are obstructed so that fluid enters the filter device at one flute but exits the filter device at a second flute. In certain embodiments the fluted filter media comprises flow restrictors along the length of the flutes. Often the flow restrictors provide structural support to prevent the filter from collapsing or tearing. Typically the flow restrictors comprise total plugs or partial flow restrictors.

In certain embodiments the activated carbon comprises activated carbon fibers, such as chemically impregnated activated carbon. In other implementations the activated carbon comprises activated carbon particles, or a combination of fibers and particles. Suitable carbon particles include, for example, those of 50 to 200 mesh. In yet other implementations the carbon can comprise a pyrolyzed polymer coated onto a high temperature fibrous substrate. The chemically impregnated activated carbon can also be treated with reactive agents of aqueous or organic solutions for acidic and/or basic gas removal.

The invention is further directed to a filter device capable of removing particulate and volatile organic compounds from stagnant or flowing streams, including nanoparticles. Such devices include fluted filter media; the fluted filter media further comprising flow restrictors and activated carbon homogeneously incorporated into the fluted filter media. In some applications these flow restrictors provide structural support to prevent the filter from collapsing or tearing, but most critically they force liquids (typically gases) flowing through the filter to pass from one flute through another flute. In some embodiments the flow restrictors comprise total plugs or partial flow restrictors.

A general understanding of some of the basic principles and problems of air filter design can be understood by consideration of U.S. Pat. Nos. 4,289,513; 5,082,476; 5,238,474; 5,364,456; and 7,052,532. The complete disclosures of these patents are incorporated herein by reference.

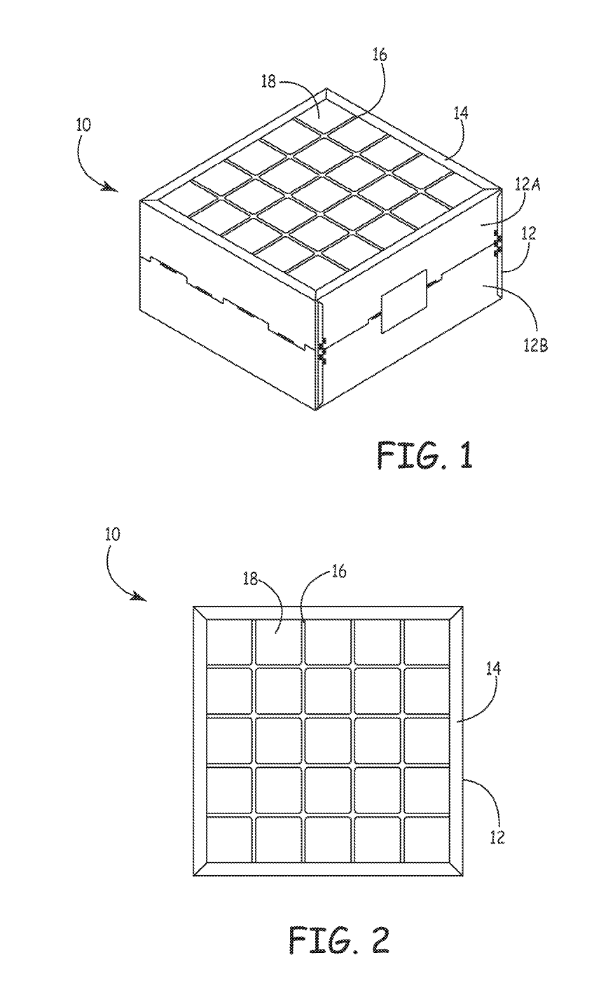

In reference first to FIGS. 1 and 2, a top perspective view and a top plan view of a filter assembly constructed in accordance with an implementation of the invention is shown. The filter assembly 10 includes a housing 12. In the depicted embodiment, the housing 12 of the filter assembly 10 includes a top portion 12A and a bottom portion 12B snapped together to contain filer media 18. The filter media 18 is further retained within the housing 12 by a lip 14 along the edge of the housing 12, along with a grid 16 running across the top (and, although not shown, bottom) of the assembly. The media 18 is shown only in end view, with the ends of the flutes visible.

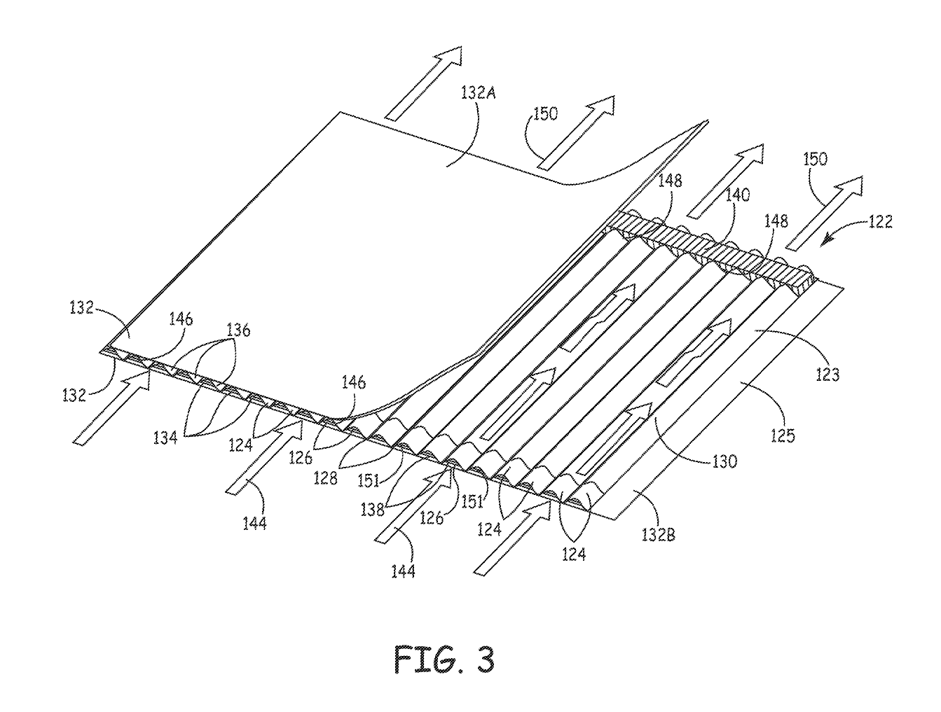

Attention is now directed to FIG. 3, depicting details of the type of media shown in FIGS. 1 and 2. FIG. 3 depicts a schematic, perspective view demonstrating the principles of operation of media usable in the filter constructions herein, including assembly 10 of FIGS. 1 and 2. In FIG. 3, a fluted construction is generally designated at 122. Preferably, the fluted construction 122 includes: a layer 123 of corrugations having a plurality of flutes 124 and a face sheet 132. The embodiment shows two sections of the face sheet 132, at 132A (depicted on top of the corrugated layer 123) and at 132B (depicted below the corrugated layer 123). Typically, the media construction 125 used in arrangements described herein will include the corrugated layer 123 secured to the bottom face sheet 132B.

The media can be provided, for example, in a wound construction or a stacked construction. When using this media construction 125 in a rolled construction, it typically will be wound around itself, such that the bottom face sheet 132B will cover the top of the corrugated layer 123. The face sheet 132 covering the top of the corrugated layer is depicted as 132A. It should be understood that the face sheet 132A and 132B are the same sheet 132 in such example embodiments.

When using this type of media construction 125, the flute chambers 124 desirably form alternating peaks 126 and troughs 128. The troughs 128 and peaks 126 divide the flutes into an upper row and lower row. In the particular configuration shown in FIG. 3, the upper flutes form flute chambers 136 closed at the downstream end, while flute chambers 134 having their upstream end closed form the lower row of flutes.

The fluted chambers 134 are closed by a first end bead 138 that fills a portion of the upstream end of the flute between the fluting sheet 130 and the second facing sheet 132B. Similarly, a second end bead 140 closes the downstream end of alternating flutes 136. In some preferred systems, both the first end bead 138 and second end bead 140 are straight along all portions of the media construction 125, typically not deviating from a straight path.

In some systems, the first end bead 138 is both straight and never deviates from a position at or near one of the ends of the media construction 125, while the second end bead 140 is both straight and never deviates from a position at or near one of the ends of the media construction 125. The flutes 124 and end beads 138, 140 provide the media construction 125 that can be formed into filter construction 100 and be (in some implementations) structurally self-supporting without a housing.

When using media constructed in the form of media construction 125, during use, unfiltered fluid, such as air, enters the flute chambers 136 as indicated by the shaded arrows 144. The upstream ends of the flute chambers 136 typically remain open. The unfiltered fluid flow is not permitted to pass through the downstream ends 148 of the flute chambers 136 because their downstream ends 148 are closed by the second end bead 140. Therefore, the fluid is forced to proceed through the fluting sheet 130 or face sheets 132. As the unfiltered fluid passes through the fluting sheet 130 or face sheets 132, the fluid is filtered to remove VOCs. The cleaned fluid is indicated by the unshaded arrow 150. The fluid then passes through the flute chambers 134 (which have their upstream ends 151 closed) to flow through the open downstream end 152 (FIG. 1) out the fluted construction 122. With the configuration shown, the unfiltered fluid can flow through the fluted sheet 130, the upper facing sheet 132A, or lower facing sheet 132B, and into a flute chamber 134.

In some embodiments the media construction 125 will be prepared and then wound to form a rolled construction of filter media. In these types of arrangements, the media construction will typically include a leading edge at one end and a trailing edge at the opposite end, with a top lateral edge and a bottom lateral edge extending between the leading and trailing edges. By the term “leading edge”, it is meant the edge that will be initially turned or rolled, such that it is at or adjacent to the center or core of the rolled construction. The “trailing edge” will be the edge on the outside of the rolled construction, upon completion of the turning or coiling process.

The leading edge and the trailing edge should be sealed between the corrugated sheet 123 and the bottom face sheet 132B, before winding the sheet into a coil, in these types of media constructions 125. While a number of ways are possible, in certain methods, the seal at the leading edge is formed as follows: (a) the corrugated sheet 123 and the bottom face sheet 132B are cut or sliced along a line or path extending from the top lateral edge to the bottom lateral edge (or, from the bottom lateral edge to the top lateral edge) along a flute 124 forming a peak 126 at the highest point (or apex) of the peak 126; and (b) sealant is applied between the bottom face sheet 132B and the sheet of corrugations 123 along the line or path of cut. The seal at the trailing edge can be formed analogously to the process of forming the seal at the leading edge.

When using the media construction 125, it may be desired by the system designer to wind the construction 125 into a rolled construction of filter media. A variety of ways can be used to coil or roll the media.

### Filter Media Composition and Method

Numerous different media may be used to form provide the substrate used to create the filter media and assemblies of the present invention. In some implementations activated carbon fibers are homogeneously or heterogeneously distributed within a polymeric binder system (fluid or fiber form) to form a continuous web such as papers or nonwovens through dry lay or wet lay processes. Suitable binders for wet lay process include nylon copolymer, polyester copolymer, bi-component heteropolymer, and polyvinyl alcohol. Suitable binders for dry lay process include thermoplastic polymers such as polyolefins, polyesters, polyamides, and latex. The activated carbon fibers incorporated into web form can be assembled to form the low pressure drop structures either by corrugating and gluing with flat sheets together or ultrasonically welding the corrugated and flat sheets together.

In ultrasonic welding processes, thermoplastic polymeric binders in upper and lower layers of activated carbon fibers melt as heat is generated from the horns of an ultrasonic welder. This heat welds the two layers together and forms the low pressure drop structure with a flute shape. The flute shape can vary from a few mm (1-2 mm) in height to 15 mm, for example. In certain implementations the flute height is less than 5 mm, in other implementations less than 10 mm, and in other implementations less than 15 mm. In some implementations the flute height is as great as 20 mm, and in some implementations the flute height is greater than 20 mm. Flute height ranges can also include, for example, from 2 to 5 mm; from 2 to 10 mm; from 5 to 10 mm; from 5 to 15 mm; from 10 to 15 mm; and from 2 to 20 mm.

To generate a filter substrate incorporating activated carbon, a polymeric carbon precursor is coated on an appropriate substrate. The substrate that composes the low pressure drop filter can include cordierite, mullite, or alumina that can withstand high pressures. Additionally, the substrate can include fabrics, papers, felts, or mats that can be shaped and also withstand high temperatures. Additionally, the substrate can be flat fabrics, papers, felts, or mats that can withstand high temperatures that are shaped after incorporation of the polymeric carbon precursor.

Low pressure drop shaped filters can be formed either before or after the coating process. The polymeric carbon precursors include natural and synthetic polymers such as polyacrylonitrile, cellulose, phenolic resin, pitch viscose, acetate, polyfurylalcohol, and the like. Various alternative methods to coat, carbonize, and activate the filter substrate can be used. In a first method, polymeric carbon precursor can be coated onto a shaped filter substrate, the polymeric carbon precursor is cured, and the polymeric carbon precursor is carbonized by physical or chemical activation. In a second method, the polymeric carbon precursor is coated on a flat filter substrate, the polymeric carbon precursor is cured, the flat filter substrate is shaped into a low pressure drop configuration, and the polymeric carbon precursor is carbonized by physical or chemical activation. In a third method, the polymeric carbon precursor is coated on a flat filter substrate, the polymeric carbon precursor is cured, the polymeric carbon precursor is carbonized by physical or chemical activation, and the flat filter substrate is then shaped into a low pressure drop configuration.

The coating process can include, for example, dip-coating filter substrates in polymeric solutions, washing or spraying with the polymeric solution, or spinning/depositing the polymeric fibers onto the filter substates. The carbonization and activation process for physical activation encompasses carbonizing the coated filter substrate in an inert atmosphere such as N₂ and then activating in CO₂, steam, or both at high temperatures. Chemical activation can include mixing inorganic activation compounds such as phosphoric acid, sulfuric acid, or zinc chloride with the polymeric carbon precursors in solvents, coating the polymeric solution onto filter substrates, and activating them in an inert atmosphere at high temperatures.

### Chemical Adsorbent Component

After the filter substrate incorporating activated carbon has been generated, the filter can be further chemically treated for various applications including the removal of acidic contaminants from the air with a strongly basic material, removal of basic contaminants from the air with a strongly acid material, or both.

Preferably, the basic materials and acidic materials are separated from each other so that they do not cancel each other. Examples of acidic compounds that are often present in atmospheric air include sulfur oxides, nitrogen oxides, hydrogen sulfide, hydrogen chloride, and volatile organic acids and nonvolatile organic acids. Examples of basic compounds that are often present in atmospheric air include ammonia, amines, amides, sodium hydroxides, lithium hydroxides, potassium hydroxides, volatile organic bases and nonvolatile organic bases. In general, the acidic and basic materials of the chemical adsorbent component of the filter removes contaminants from the air by trapping the contaminants on their surfaces; typically, the acidic and basic surfaces react with the contaminants, thus adsorbing the contaminants at least on the surfaces.

Example methods and materials for incorporation of a chemical adsorption element are described in U.S. published application No. 20060042210, published Mar. 2, 2006, and incorporated by reference in its entirety, and PCT application WO 2006/026517, published Mar. 9, 2006, and also incorporated by reference in its entirety.

### EXAMPLES AND EXPERIMENTAL DATA

Example formulations for filter media made in accordance with the present invention, and their corresponding performance, are shown below.

### Sample Media No. 1

A first sample media was constructed in accordance with the invention was produced and tested for various properties. The media had an average thickness of 0.0386 inches, and a basis weight of 94.72 gsm. Media was produced using 20 percent VPX 203 (a binder); 60 percent carbon fibers, and 20 percent Twaron 3094 (a high fibrillation, short fiber aramid fiber produced by Teijin Aramid BV and used as a binder).

TABLE 1

| | Dry Tensile | Elon- | Dry Tensile | Elon- | Perme- | Gurley | Gurley |
|---|---|---|---|---|---|---|---|
| | Load (lbs/ | gation | Load (lbs/ | gation | ability | Stiffness | Stiffness |
| Trial | in.) MD | (%) MD | in.) CMD | (%) CMD | cfm @125 Pa | MD (mg) | CMD (mg) |
| 1 | 12.912 | 2.757 | 13.564 | 3.183 | 151 | 1820.4 | 1387.5 |
| 2 | 11.794 | 2.457 | 13.489 | 3.183 | 153 | 1354.2 | 1198.8 |
| 3 | 12.089 | 3.032 | 13.043 | 2.96 | 152 | 1554 | 1520.7 |
| 4 | 13.166 | 3.064 | 13.701 | 3.077 | 155 | 1676.1 | 1687.2 |
| 5 | 13.228 | 2.919 | 13.777 | 3.279 | 153.6 | 1742.7 | 1620.6 |
| AVG | 12.638 | 2.846 | 13.515 | 3.136 | 152.92 | 1629.48 | 1482.96 |
| STDEV | 0.655 | 0.248 | 0.287 | 0.122 | 1.53 | 182.29 | 194.90 |

### Sample Media No. 2

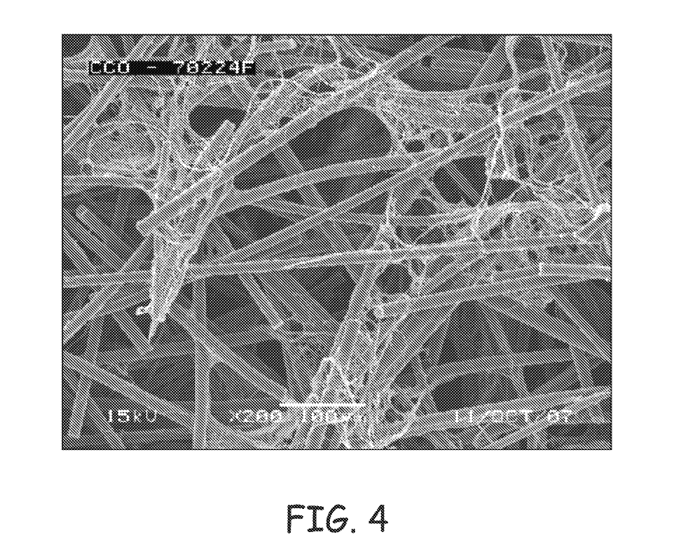

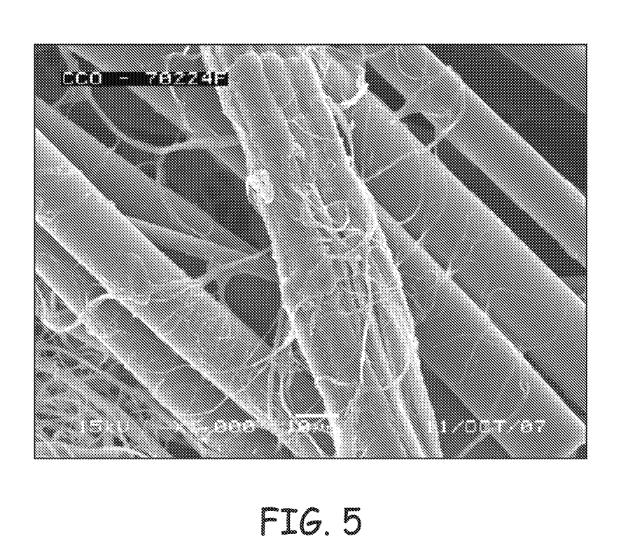

A first sample media was constructed in accordance with the invention was produced and tested for various properties. The media had an average thickness of 0.0464 inches, and a basis weight of 93 gsm. FIG. 4 shows an SEM image of Sample Media No. 2 at 200 times magnification, and FIG. 5 shows an SEM image of Sample Media No. 2 at 1000 times magnification. The media was produced using 10 percent Twaron 1080 (a substantially nonfibrillated aramid fiber produced by Teijin Aramid BV); 20 percent Twaron 3094 (a high fibrillation, short fiber aramid fiber produced by Teijin Aramid BV); and 70 percent carbon fibers.

TABLE 2

| | Dry Tensile | Elon- | Dry Tensile | Elon- | Perme- | Gurley | Gurley |
|---|---|---|---|---|---|---|---|
| | Load (lbs/ | gation | Load (lbs/ | gation | ability | Stiffness | Stiffness |
| Trial | in.) MD | (%) MD | in.) CMD | (%) CMD | cfm @125 Pa | MD (mg) | CMD (mg) |
| 1 | 7.081 | 1.703 | 7.979 | 1.828 | 288 | 1232.1 | 1110 |
| 2 | 7.183 | 1.654 | 8.281 | 2.125 | 285 | 1298.7 | 1110 |
| 3 | 7.506 | 1.639 | 8.501 | 1.717 | 280 | 1098.9 | 1143.3 |
| 4 | 8.37 | 1.818 | 7.65 | 1.815 | 276 | 1243.2 | 888 |
| 5 | 7.499 | 1.627 | 8.412 | 1.933 | 279 | 1298.7 | 1187.7 |
| AVG | 7.528 | 1.688 | 8.165 | 1.884 | 281.6 | 1234.32 | 1087.8 |
| STDEV | 0.507 | 0.078 | 0.349 | 0.155 | 4.83 | 81.72 | 116.15 |

### Sample Media No. 3

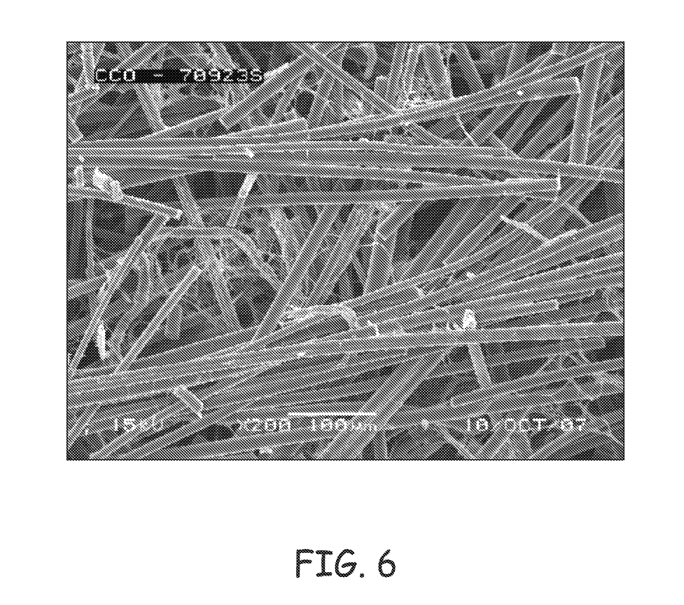

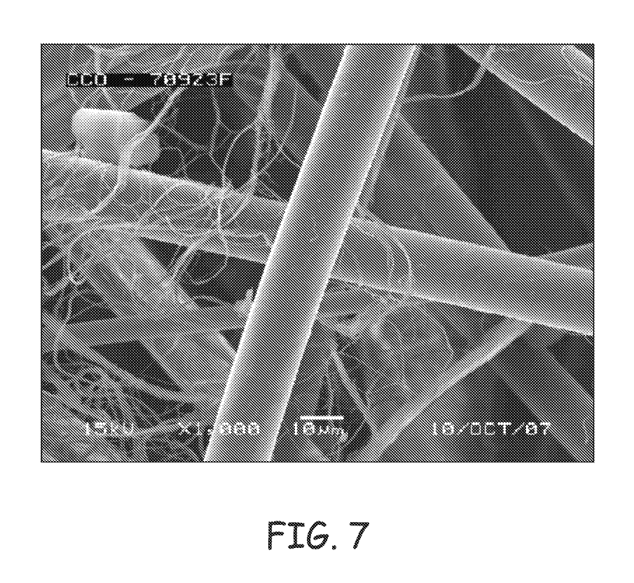

A first sample media was constructed in accordance with the invention was produced and tested for various properties. Average thickness of 0.0606 inches, with a basis weight of 151.56 gsm. FIG. 6 shows an SEM image of Sample Media No. 3 at 200 times magnification, and FIG. 7 shows an SEM image of Sample Media No. 3 at 1000 times magnification. The media was produced using 10 percent VPX 203 2d (used as a binder); 10 percent Twaron 1093 (a substantially nonfibrillated aramid fiber produced by Teijin Aramid BV); and 80 percent activated carbon fibers.

TABLE 3

| | Dry Tensile | Elon- | Dry Tensile | Elon- | Perme- | Gurley | Gurley |
|---|---|---|---|---|---|---|---|
| | Load (lbs/ | gation | Load (lbs/ | gation | ability | Stiffness | Stiffness |
| Trial | in.) MD | (%) MD | in.) CMD | (%) CMD | cfm @125 Pa | MD (mg) | CMD (mg) |
| 1 | 6.25 | 2.059 | 7.032 | 1.939 | 198 | 1642.8 | 1154.4 |
| 2 | 7.115 | 1.956 | 6.154 | 1.962 | 198 | 1209.9 | 1243.2 |
| 3 | 6.292 | 1.647 | 6.765 | 2.004 | 194 | 1343.1 | 1332 |
| 4 | 5.386 | 1.696 | 6.051 | 1.669 | 197 | 1454.1 | 1054.5 |
| 5 | 6.209 | 1.857 | 6.724 | 1.848 | 200 | 1265.4 | 1565.1 |
| AVG | 6.250 | 1.843 | 6.545 | 1.884 | 197.4 | 1383.06 | 1269.84 |
| STDEV | 0.612 | 0.173 | 0.423 | 0.133 | 2.19 | 171.71 | 194.58 |

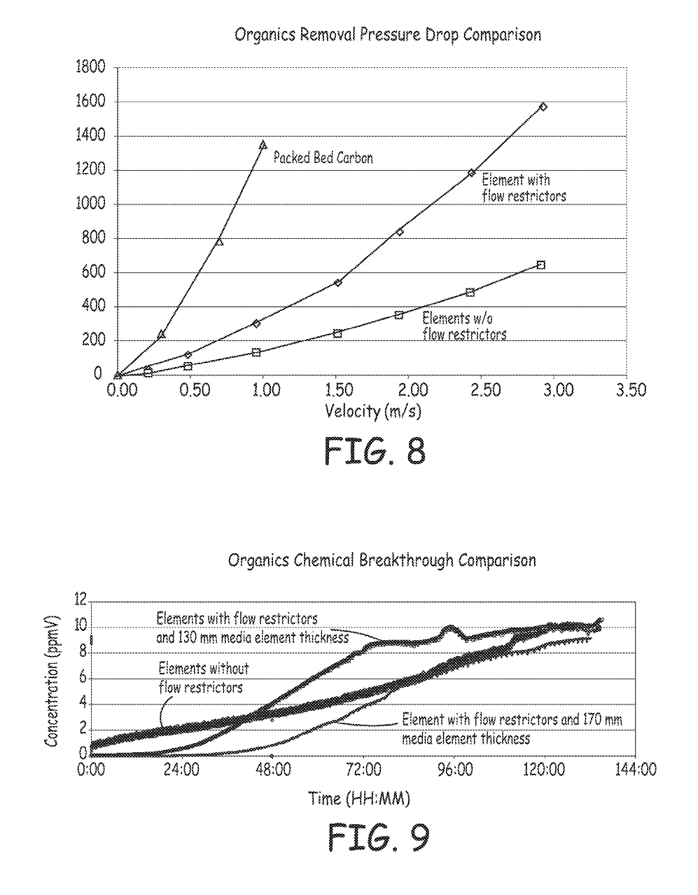

In reference now to FIG. 8 and FIG. 9, properties of filter elements made in accordance with the present invention are shown. FIG. 8 shows the difference in pressure drop between a 25 mm thick packed carbon bed, n element made in accordance with the present invention having flow restrictors, and an element made in accordance with the present invention without flow restrictors. FIG. 9 shows chemical breakthrough using an HMDSO contaminant at an upstream concentration of 10 ppm, at approximately 53 percent RH, a temperature of 25 to 26° C., and a face velocity (m/sec) of 0.20.

This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

We claim:

1. Media for removing organic compounds from a fluid stream, the media comprising:
at least 50 percent activated carbon by weight; and
a binder material securing the activated carbon into a flexible sheet suitable for forming into filter elements;
wherein the sheet undergoes bending without significant degradation of the integrity of the sheet or activated carbon.

2. The media for removing organic compounds from a fluid stream of claim 1, wherein the media contains at least 60 percent activated carbon by weight.

3. The media for removing organic compounds from a fluid stream of claim 1, wherein the media is formed by a wet-laid process.

4. The media for removing organic compounds from a fluid stream of claim 1, wherein the media is formed by a dry-laid process.

5. The media for removing organic compounds from a fluid stream of claim 1, wherein the binder is selected from the group nylon copolymer, polyester copolymer, bi-component heteropolymer, polyvinyl alcohol, polyolefins, polyesters, polyamides, latex and combinations thereof.

6. The media for removing organic compounds from a fluid stream of claim 1, wherein the media further comprises ceramic material.

7. The media for removing organic compounds from a fluid stream of claim 1, wherein the ceramic material comprises a fiber.

8. The media for removing organic compounds from a fluid stream of claim 1, wherein the activated carbon comprises carbon fibers.

9. The media for removing organic compounds from a fluid stream of claim 1, wherein the activated carbon comprises carbon particles.

10. A filter device capable of removing organic compounds from fluids, the filter device comprising:
a. fluted filter media comprising a plurality of flutes extending from a first end to a second end of the filter media; and
b. activated carbon incorporated into fluted filter media;
wherein activated carbon comprises at least 50 percent by weight of the fluted filter media.

11. The filter device of claim 10, wherein at least some of the plurality of flutes are obstructed such that fluid enters the filter device at a first set of flutes but exits the filter device at a second set of flutes.

12. The filter device of claim 10, wherein at least some of the plurality of flutes are not obstructed such that fluid enters the filter device at a first set of flutes and exits the filter device through the same first set of flutes.

13. The filter device of claim 10, wherein the fluted filter media comprises flow restrictors along the length of the flutes.

14. The filter device of claim 13, wherein the flow restrictors provide structural support to prevent the filter from collapsing or tearing.

15. The filter device of claim 13, wherein the flow restrictors comprise total plugs or partial flow restrictors.

16. The filter device of claim 10, wherein the filter device demonstrates a pressure drop of less than 16 inches of water at an airflow of less than 160 scfm.

17. The filter device of claim 10, wherein the fluted filter media contains at least 50 percent activated carbon by weight.

18. The filter device of claim 10, wherein the fluted filter media contains at least 60 percent activated carbon by weight.

19. The filter device of claim 10, wherein the fluted filter media comprises a binder selected from the group nylon copolymer, polyester copolymer, bi-component heteropolymer, polyvinyl alcohol, polyolefins, polyesters, polyamides, latex, and combinations thereof.

20. The filter device of claim 10, wherein the fluted filter media further comprises a ceramic material.

21. The filter device of claim 10, wherein the activated carbon further comprises chemically impregnated activated carbon.

22. The filter of claim 21, wherein the chemically impregnated activated carbon is treated with reactive agents of aqueous or organic solutions for acidic and/or basic gas removal.

23. The filter of claim 10, wherein the activated carbon is homogeneously incorporated into the fluted filter media.

24. The filter of claim 10, wherein the activated carbon comprises activated carbon fibers.

25. The filter of claim 10, wherein the activated carbon comprises activated carbon particles.

26. A method of removing organic contaminants from an air stream, the method comprising:
providing a filter device capable of removing organic compounds from fluids, the filter device comprising fluted filter media comprising a plurality of flutes extending from a first end to a second end of the filter media; and activated carbon incorporated into fluted filter media;
wherein activated carbon comprises at least 50 percent by weight of the fluted filter media; and
passing an air stream through the filter device;
wherein the filter device has a pressure drop of less than 16 inches of water at an airflow of less than 160 scfm.

27. The method of removing organic contaminants of claim 26, wherein at least some of the plurality of flutes are obstructed such that fluid enters the filter device at a first set of flutes but exits, the filter device at a second set of flutes.

28. The method of removing organic contaminants of claim 26, wherein at least some of the plurality of flutes are not obstructed such that fluid enters the filter device at a first set of flutes and exits the filter device at the same first set of flutes.

29. The method of removing organic contaminants of claim 26, wherein the activated carbon further comprises activated carbon fibers.

30. The method of removing organic contaminants of claim 26, wherein the activated carbon further comprises chemically impregnated activated carbon.
